(19) United States
(12) Patent Application Publication
(10) Pub. No.: US 2015/0225646 A1
(43) Pub. Date: Aug. 13, 2015

(54) POROUS GELS AND USES THEREOF

(71) Applicant: MOASIS INC., Union City, CA (US)

(72) Inventors: Naihong Li, Union City, CA (US); Jen-chieh Wu, Union City, CA (US)

(21) Appl. No.: 14/424,980

(22) PCT Filed: Aug. 30, 2013
(86) PCT No.: PCT/CA2013/050673

§ 371 Date: Feb. 27, 2015

Related U.S. Application Data
(60) Provisional application No. 61/695,157, filed on Aug. 30, 2012.

(51) Int. Cl. C09K 17/22; A01C 1/02; C08L 33/02; C08J 3/075; C08J 3/24

(52) U.S. Cl. CPC C09K 17/22; C08J 3/075; C08J 3/24; C08L 33/02; A01C 1/02; C08J 2333/02; C08J 2371/02

(57) ABSTRACT

Hydrogels having a porosity of at least about 5%, comprising a first polymeric material comprising a polymer derived from a monomer with a vinyl functionality, and a second polymeric material having a polyglycol other than polyethylene glycol are described. A method of forming a porous hydrogel, by mixing in a reaction vessel, a mixture comprising a monomer having a vinyl functionality, a crosslinker, an organic solvent, a first polymeric material comprising polyacrylic acid and a second polymeric material comprising a polyglycol other than polyethylene glycol, and mixing the mixture to form the hydrogel having a porosity of at least about 5%. Also described are an agricultural method and a system (a seed in a seed container).

### CROSS-REFERENCE TO RELATED APPLICATIONS

This application is related and claims priority to U.S. Provisional Patent Application No. 61/695,157 filed Aug. 30, 2012, which is hereby incorporated herein by reference in its entirety.

### BACKGROUND

Polymeric gels and hydrophilic hydrogels having three-dimensional structures can have many important applications as matrices for use in biomedical, pharmaceutical, agriculture, biotechnology and industrial composite fields. These polymeric gels and hydrogels can have a three-dimensional (“3D”) structure due to cross-linking; the cross-linked materials might be insoluble in organic solvents and water.

Polymeric gels and hydrogels may be produced by the polymerization of monomers or multifunctional monomers with cross-linkers with the aid of one or more catalysts, sometimes at high temperatures. This can lead to high materials costs and processing costs.

### SUMMARY

Porous materials, and more particularly porous polymer materials, may have various uses and applications, such as separation and purification in the chemical industry, for cell culture and immobilization of enzymes in biological sciences, for controlled drug release in drug formulations, and as artificial organs in bioengineering, for example.

At least some polymer materials used in the agricultural area are hydrophilic polymers, such as hydrogels. The mechanical strength of such polymer (or polymeric) materials may be relatively weak, ordinarily making them ill-suited for use as porous materials in an agricultural setting. Recognized herein is the need for porous hydrogels that have improved mechanical properties over other gels and hydrogels.

In one aspect, the present disclosure provides for porous polymeric gels (e.g., hydrogels). In another aspect, this disclosure also provides methods for forming such gels, including by using a specifically designed polymerization reactor and further for example by using a three dimensional (3D) skeleton structure to increase the mechanical strength of the gel, and preferably also to provide higher water absorbency. In one such embodiment, the 3D skeleton structure can be constructed by application of a double crosslink system.

According to one embodiment, polymeric materials and porous polymer materials of the disclosure may be used for example and without limitation for separation and purification in the chemical industry, for cell culture and immobilization of enzymes in biological science, for controlled drug release in drug formulation, and as artificial organs in bioengineering. In a particular embodiment, porous gels provided herein can have advantages over non-porous hydrogel, such as their ability to absorb water quickly, and their increased capacity for fluids, such as water.

In one aspect, the present disclosure provides compositions of porous hydrogels and methods of making them. Additionally, an embodiment of the present invention provides for methods of using porous hydrogels in areas of application, such as for example, agriculture.

In one aspect, the present disclosure provides a hydrogel, comprising: a first polymeric material comprising a polymer derived from a monomer with a vinyl functionality, and a second polymeric material having a polyglycol other than polyethylene glycol, wherein the hydrogel has a porosity of at least 5%.

In one embodiment, the first polymeric material may comprise a cross-linker. In one such embodiment, the cross-linker may be selected from the group consisting of di(ethyleneglycol) divinyl ether, di(ethylglycol) diacrylate, and N,N′-methylene bis(acrylamide). In some embodiments, the first polymeric material is a cross-linked polyacrylic acid.

In one embodiment, the second polymeric material may be substantially a homopolymer. In some embodiments, the second polymeric material is polytetramethylene ether glycol. In some embodiments, the first polymeric material is hydrogen-bonded to the second polymeric material. In one embodiment, the Mw (g/mol) of the second polymeric material may be from about 650 to about 2,000. In some embodiments, the second polymeric material has an Mw (g/mol) between about 500 and 1000.

According to a further embodiment, the hydrogel may further comprise a third polymeric material. The third polymeric material may be a homopolymer of acrylic acid. In some cases, the third polymeric material is substantially non-porous. The Mw (g/mol) of the third polymeric material may be from about 250,000 to about 1,000,000. In some embodiments, the third polymeric material has an Mw (g/mol) between about 400,000 and 600,000.

In some embodiments, the hydrogel may have a porosity of at least about 5%, at least about 10%, at least about 20%, at least about 30%, at least about 40%, at least about 50%, at least about 60% or at least about 70%, for example.

In one embodiment, the monomer may be selected from the group consisting of acrylic acid, methylacrylic acid, vinyl alcohol, vinyl acetate, butyl acrylate, vinyl acrylate, vinylbenzoic acid, vinylbenzyl alcohol, vinylboronic acid dibutyl ester, vinylformamide, vinyl methacrylate, vinylpyridine, 1-vinyl-2-pyrrolidone, vinylsulfonic acid, and vinyltrimethoxysilane.

In a particular embodiment, the hydrogel may remain substantially unchanged after 1, 2, 5, 10, 50, or 100 hydration-dehydration cycles, for example. In one such embodiment, the hydrogel may have a water-retention capacity of at least about 10, at least about 20, at least about 30, or at least about 50 times the weight of the hydrogel. In another such embodiment, the hydrogel may have a water-retention capacity of at least about 10%, at least about 20%, at least about 30%, at least about 40%, at least about 50%, at least about 60%, at least about 100%, or at least about 1000% of the weight of the hydrogel, for example.

In one embodiment, the ratio, by weight, of the first polymeric material to the second polymeric material may be about 1-to-1, about 1-to-2, about 1-to-3, about 1-4, about 1-5, or about 1-6. The ratio, by weight, of the first polymeric material to the second polymeric material may be about 2-to-1, about 3-to-1, about 4-to-1, about 5-to-1, or about 6-to-1. The ratio, by weight, of the first polymeric material to the third polymeric material may be about 1-to-1, about 1-to-1.2, about 1-to-1.5, about 1-to-2, about 1-to-2.5, about 1-to-3, about 1-to-4, about 1-to-5, or about 1-to-6. The ratio, by weight, of the first polymeric material to the third polymeric material may be about 1.2-to-1, about 1.5-to-1, about 2-to-1, about 2.5-to-1, about 3-to-1, about 4-to-1, about 5-to-1, or about 6-to-1.

In a particular embodiment, the first polymeric material may increase the water absorption rate of the hydrogel. In some embodiments, the hydrogel absorbs water at a rate of at least 1.5 times of the rate of a hydrogel composition lacking the first polymeric material. In some other embodiments, the hydrogel absorbs water at a rate of at least 2 times of the rate of a hydrogel composition lacking the first polymeric material.

In one embodiment, a porous cross-linked polymeric material according to an embodiment of the present invention may be produced by polymerization of a water-in-oil and oil-in-water emulsion. In a particular such embodiment, the water absorption rate and kinetics of water adsorption of the cross-linked polymeric material may desirably relate to and may be influenced by the porous structure of the polymeric material. In one such embodiment, the porous cross-linked polymeric material may comprise a porous hydrogel, for example. In one case, porous materials according to an embodiment of the invention may desirably have a relatively large surface area and/or specific surface area, and also a desirably high porosity and vacancy or void space within the material. These voids or vacancies within a porous polymeric material according to an embodiment of the invention may desirably enhance the entrance of liquids into the polymer particle for adsorption, as well as the observed absorption rate. In a particular exemplary embodiment, a porous structure may be introduced and/or formed in a polymeric material according to an embodiment of the invention by emulsion polymerization, for example. In one such embodiment, an emulsion system is comprised of an aqueous phase containing a monomer with a crosslinking agent, and an organic phase containing an organic solvent, for example. In one such embodiment utilizing such an emulsion system and emulsion polymerization, porous polymer particles with desirably high mechanical strength and desirably rapid water absorption rate may be produced.

In another aspect, the present disclosure provides a method of forming a porous hydrogel, comprising: providing, in a reaction vessel, a monomer having a vinyl functionality, a cross-linker, an organic solvent, a first polymeric material comprising polyacrylic acid, and a second polymeric material comprising a polyglycol other than polyethylene glycol, and mixing the mixture. In one embodiment, the first polymeric and/or the second polymeric material may be substantially a homopolymer.

In a particular embodiment, the ratio, by weight, of the first polymeric material and the second polymeric material may be about 1-to-1, about 1-to-2, about 1-to-3, about 1-to-4, about 1-to-5, or about 1-to-6. In other embodiments, the ratio, by weight, of the first polymeric material to the second polymeric material may be about 2-to-1, about 3-to-1, about 4-to-1, about 5-to-1, or about 6-to-1.

In a further embodiment, the method may further comprise heating the mixture. In some embodiments, the mixture is heated at a temperature between about 50° C. and 90° C. for at least 1 hour or at least 2 hours.

In one embodiment, the monomer may selected from the group consisting of acrylamide, acrylic acid, methylacrylic acid, vinyl alcohol, vinyl acetate, butyl acrylate, vinyl acrylate, vinylbenzoic acid, vinylbenzyl alcohol, vinylboronic acid dibutyl ester, vinylformamide, vinyl methacrylate, vinylpyridine, 1-vinyl-2-pyrrolidone, vinylsulfonic acid, and vinyltrimethoxysilane. The cross-linker is selected from the group consisting of di(ethyleneglycol) divinyl ether, di(ethylglycol) diacrylate, and N,N′-methylene bis(acrylamide). Additionally, the polyacrylic acid may be obtained from recycled polyacrylic acid.

In some embodiments, the solvent may toluene.

In another aspect, an embodiment of the present invention provides an agricultural method, comprising: providing a hydrogel in a plot of soil, wherein the hydrogel may a porosity of at least about 5%, at least about 10%, at least about 20%, at least about 30%, at least about 40% at least about 50%, or at least about 60%.

In one such embodiment, the hydrogel may comprise three polymeric materials: a first polymeric material comprising substantially porous polyacrylic acid, a second polymeric material comprising polytetramethylene ether glycol, and a third polymeric material comprising substantially non-porous polyacrylic acid. In some embodiments, the first polymeric material is a cross-linked polyacrylic acid. The second polymeric material may be substantially a homopolymer. In some embodiments, the second polymeric material is polytetramethylene ether glycol. The third polymeric material may be substantially a homopolymer. In some embodiments, the third polymeric material is a polyacrylic acid.

In some embodiments, the hydrogel may remain substantially unchanged after 1, 2, 5, 10, 50, or 100 hydration-dehydration cycles. In a further embodiment, the hydrogel may have a water-retention capacity of at least about 10, at least about 20, at least about 30, or at least about 50 times the weight of the hydrogel. In another embodiment, the hydrogel may have a water-retention capacity of at least about 10%, at least about 20%, at least about 30%, at least about 40%, at least about 50%, at least about 60%, at least about 100%, or at least about 1000% of the weight of the hydrogel.

In one embodiment, the ratio, by weight, of the first polymeric material to the second polymeric material may be about 1-to-1, about 1-to-2, about 1-to-3, about 1-4, about 1-5, or about 1-6. In another embodiment, the ratio, by weight, of the first polymeric material to the second polymeric material may be about 2-to-1, about 3-to-1, about 4-to-1, about 5-to-1, or about 6-to-1. In a further embodiment, the ratio, by weight, of the first polymeric material to the third polymeric material may be about 1-to-1, about 1-to-1.2, about 1-to-1.5, about 1-to-2, about 1-to-2.5, about 1-to-3, about 1-to-4, about 1-to-5, or about 1-to-6. In another embodiment, the ratio, by weight, of the first polymeric material to the third polymeric material may be about 1.2-to-1, about 1.5-to-1, about 2-to-1, about 2.5- to-1, about 3-to-1, about 4-to-1, about 5-to-1, or about 6-to-1.

In yet another aspect, an embodiment of the present disclosure provides a system, comprising: a seed container formed of a hydrogel with a porosity of at least about 5%; and a seed in said seed container.

In one such embodiment, the hydrogel has a porosity of at least about 10%.

In a particular embodiment, the hydrogel may comprise three polymeric materials: a first polymeric material comprising substantially porous polyacrylic acid, a second polymeric material comprising polytetramethylene ether glycol, and a third polymeric material comprising substantially non-porous polyacrylic acid.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

Novel features of specific embodiments of the present invention are set forth with particularity in the appended claims. A better understanding of the features and advantages of the present invention will be obtained by reference to the following detailed description that sets forth illustrative embodiments, in which the principles of the invention are utilized, and to the accompanying drawings of which:

FIG. 1 shows an isometric view of an exothermic polymerization reactor according to one embodiment of the invention.

### DETAILED DESCRIPTION

While several preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein can be employed in practicing the invention.

The term “polymeric material,” as used herein, includes a material having one or more monomeric subunits (also “units” herein). In an embodiment, a polymeric material can include one or more types of repeating subunits. In another embodiment, a polymeric material can include the same type of repeating subunit. In another embodiment, a polymeric material can include two or more different types of repeating subunits. In another embodiment, a polymeric material can include monomeric subunits bonded to one another. In another embodiment, a polymeric material can include monomeric subunits bonded to another with the aid of covalent bonds.

The term “gel,” as used herein, can include a material comprising one or more types of polymeric materials bonded together. In an embodiment, a gel (also “polymeric gel” herein) can include one or more types of polymeric materials bonded together to form a three-dimensional structure. In another embodiment, a gel can include two types of polymeric materials bonded together to form a three-dimensional structure (or three-dimensional network). In another embodiment, a gel can include one or more types of polymeric materials bonded to one another with the aid of hydrogen bonds. In another embodiment, a gel can include one or more types of polymeric materials bonded to one another solely with the aid of hydrogen bonds. In another embodiment, a first polymeric material having one or more monomeric subunits is hydrogen-bonded to a second polymeric material having one or more monomeric subunits. In another embodiment, the hydrogen bonds are formed between hydrogen atoms of a first polymeric material and electronegative atoms (e.g., oxygen, nitrogen or fluorine).

The term “hydrogel” (also referred to as “aquagel”), as used herein, is any substance that is configured to retain water. A hydrogel can include hydrophilic moieties, i.e., groups or subgroups that can have an attractive interaction with one or more water molecules. Hydrogels formed according to methods described herein can have water retention capabilities equal to or exceeding those of current hydrogels.

The term “homopolymer,” as used herein, refers to any polymeric substance that is composed of the same kind of a monomer. For example, a homopolymer of acrylic acid is a polymer that is composed only of acrylic acid. The phrase “substantially a homopolymer,” as used herein, refers to a polymeric material that is composed of about 80%, or about 81%, or about 82%, or about 83%, or about 84%, or about 85%, or about 86%, or about 87%, or about 88%, or about 89%, or about 90%, or about 91%, or about 92%, or about 93%, or about 94%, or about 95%, or about 96%, or about 97%, or about 98%, or about 99%, or about 99.5%, or about 99.9%, or about 99.95%, of the same kind of monomer unit. For example, when a material having polyacrylic acid is substantially a homopolymer, at least 80% of the material is composed of acrylic acid monomer units. For another example, when a material having a polyglycol is substantially a homopolymer, at least 80% of the material is composed of the same glycol monomer units. For example, when a polymeric material having polytetramethylene ether glycol (“PTMEG”) is substantially a homopolymer, it is composed of at least 80% of polytetramethylene ether glycol monomer units.

The phrase “substantially unchanged,” as used herein, refers to gels or hydrogels that exhibit about the same mass after a hydration-dehydration cycle as before a hydration-dehydration cycle.

The term “porosity,” as used herein, refers to a measure of void spaces (e.g., emptiness) in a material, and may be a fraction of the volume of voids over the total volume. Porosity in some cases can be in the range of 0% to 100%.

According to one embodiment, the above or below described porous gel or hydrogel materials can be further blended with other materials, such as, e.g., polyethylene or polystyrene to form polymeric composites with high tensile and impact strength.

Provided herein are porous gels and hydrogels according to several embodiments of the invention that can be used in various applications in some embodiments, such as water retention systems for agricultural purposes. Certain porous gels and hydrogels provided as embodiments of the present invention herein are based at least in part on the unexpected realization that the combination of certain components, as provided herein, can lead to the formation of gels and hydrogels with properties that are suited for such applications, such as high water retention capacities. For example, a porous gel having polyacrylic acid and polytetramethylene ether glycol is environmentally friendly and does not lead to environmental contamination during extended use. Gels and hydrogels have also been described in WO/2012/064787 (PCT/US2011/059837), which is entirely incorporated herein by reference.

### Porous Gels and Hydrogels

In one embodiment of the present invention, porous gels or hydrogels may have one or more advantages over non-porous gels and hydrogels, such as absorbing water quickly and absorbing larger amounts of water, for example. Additionally, according to an embodiment, porous gels or hydrogels may have improved air properties compared to that of non-porous gels or hydrogels, which may be important for agricultural applications.

In an aspect of the invention, a porous gel (also “gel-like substance” herein), is provided. In one such embodiment, the porous gel may be a mixture of two or more polymeric materials that are hydrogen bonded to one another. The polymeric materials can be hydrogen bonded to one another through one or more subunits of the polymeric materials. At least one of polymeric materials is desirably porous. In some embodiments, the porous polymeric material comprises a cross-linker. In one such embodiment, the cross-linker may be selected from the group consisting of di(ethyleneglycol) divinyl ether, di(ethylglycol) diacrylate, and N,N′-methylene bis(acrylamide).

In some embodiments, a porous gel includes 1 or more, 2 or more, 3 or more, 4 or more, 5 or more, 6 or more, 7 or more, 8 or more, 9 or more, or 10 or more types of polymeric materials that are hydrogen bonded to one another.

In some exemplary embodiments, a porous gel is provided having a first polymeric material, a second polymeric material and a third polymeric material. In one embodiment, the first polymeric material is a cross-linked polyacrylic acid. In another embodiment, the first polymeric material is hydrogen-bonded to the second polymeric material. In another embodiment, the first polymeric material is linked to the second polymeric material exclusively through hydrogen-bonding interactions. In another embodiment, the third polymeric material is a linear polyacrylic acid (“PAA”) and the second polymeric material is a polyglycol. In another embodiment, the third polymeric material is a linear PAA and the second polymeric material is polytetramethylene ether glycol (“PTMEG”). In some embodiments, the third polymeric material is hydrogen-bonded to the second polymeric material. In another embodiment, the second polymeric material is hydrogen-bonded to the first and third polymeric materials. In another embodiment, the first polymeric material is a cross-linked PAA, the second polymeric material is a PTMEG, and the third polymeric material is a PPA. In another embodiment, the first polymeric material is a cross-linked PAA, the second polymeric material is PTMEG, and the third polymeric material is a linear PPA. In some embodiments, the first polymeric material is porous. In a further embodiment, the hydrogel mixture has a porosity of at least about 5%, at least about 10%, at least about 20%, at least about 30%, at least about 40%, at least about 50%, at least about 60% or at least about 70%, for example.

In an embodiment, a porous gel comprises polyacrylic acid (or poly(acrylic acid), “PAA”) and a polyglycol. In some embodiments, a porous gel further comprises a monomer of acrylic acid. In some embodiments, a porous gel comprises a vinyl-containing monomer (also referred to as “vinyl-containing material” herein), such as acrylamide, methylacrylic acid, vinyl alcohol, vinyl acetate, butyl acrylate, vinyl acrylate, vinylbenzoic acid, vinylbenzyl alcohol, vinylboronic acid dibutyl ester, vinylformamide, vinyl methacrylate, vinylpyridine, 1-vinyl-2-pyrrolidone, vinylsulfonic acid and vinyltrimethoxysilane, for example. In some embodiments, a porous gel comprises a vinyl-containing polymer (also referred to as “vinyl-containing material” herein). In one embodiment, when a vinyl-containing material is an acid, a porous gel may comprise a salt derivative of the acid. For example, when the monomer is acrylic acid, a porous gel may comprise a sodium or potassium salt of acrylic acid, or a sodium or potassium salt of polyacrylic acid. In some embodiments, the vinyl-containing material is covalently bonded to polyacrylic acid.

In an embodiment, a porous gel comprises poly(acrylic acid) (“PAA”) and one or more polyglycols, the one or more polyglycols selected from polyethylene glycol (PEG), polytetramethylene ether glycol (PTMEG), and polypropylene ether glycol (PPG). In another embodiment, a porous gel comprises PAA and PPG.

In an embodiment, a porous gel, including a porous hydrogel, comprises a first polymeric material and a second polymeric material, the second polymeric material having —O—(CH₂)ₙ subunits, wherein ‘n’ is a number greater than or equal to 2, or 3, or 4, or 5, or 6, or 7, or 8, or 9, or 10, or 11, or 12, or 13, or 14, or 15, or 16, or 17, or 18, or 19, or 20. In another embodiment, ‘n’ is greater than or equal to 2. In another embodiment, ‘n’ is greater than or equal to 3. In another embodiment, ‘n’ is greater than or equal to 4. In such a case, the second polymeric material can be PTMEG. In another embodiment, the porous gel can include a third polymeric material. In some embodiments, the third polymeric material is a linear PPA. In another embodiment, the porous gel can include hydrogen-bonding interactions between polymeric materials.

In an embodiment, a porous gel comprises a first polymeric material and a second polymeric material, the second polymeric material having —O—(CH₂CH₂)ₘ subunits, wherein ‘m’ is a number greater than or equal to 1, or 2, or 3, or 4, or 5, or 6, or 7, or 8, or 9, or 10, or 11, or 12, or 13, or 14, or 15, or 16, or 17, or 18, or 19, or 20. In another embodiment, ‘m’ is greater than or equal to 2. In such a case, the second polymeric material can be PTMEG. In another embodiment, ‘m’ is greater than or equal to 3. In another embodiment, ‘m’ is greater than or equal to 4. In an example, the first polymeric material can include a polymeric material that is hydrogen bonded to the second polymeric material. In some embodiments, the first polymeric material can include PAA. In another embodiment, the porous gel can include hydrogen-bonding interactions between polymeric materials.

In an embodiment, a porous gel comprises polyacrylic acid (PAA) and a polyglycol having average molecular weights selected to provide gel properties as desired. In another embodiment, a gel comprises PAA and PTMEG having average molecular weights selected to provide gel properties as desired.

In some embodiments, a porous gel comprises PAA having an average molecular weight (M_{w}) between about 1,800 to about 4,000,000 (g/mol). In an embodiment, a gel comprises a polyglycol having an average molecular weight (M_{w}) of at least about 250, or at least about 650, or at least about 1000, or at least about 2000, or at least about 3000, for example.

### Environmentally Friendly Porous Gels and Hydrogels

In an aspect of the invention, environmentally friendly porous gels and hydrogels are provided. In one embodiment, environmentally friendly porous gels and hydrogels may desirably be non-toxic and/or biodegradable. According to one embodiment, non-toxic and biodegradable hydrogels can be prepared by using a first polymeric material, such as a cross-linked polyacrylic acid, and a second polymeric material, such as an environmentally friendly polyglycol, and a third polymeric material, such as a linear polyacrylic acid. In some cases, the first polymeric material is porous. In some embodiments, the first polymeric material may desirably have a porosity of at least 10%. In one embodiment, such non-toxic and biodegradable hydrogels may desirably be friendly to the environment (also referred to as “environmentally-friendly hydrogels” herein), as they minimize, if not preferably eliminate, the production of hazardous components, thereby minimizing, if not eliminating, the risk of hazardous components from entering (or leaching into) water supplies, for example. In some embodiments, the environmentally friendly polyglycol is polytetramethylene ether glycol (PTMEG).

In some embodiments, an environmentally friendly porous hydrogel is blended with polyethylene. In one such embodiment, a blend of an environmentally friendly hydrogel and polyethylene may desirably exhibit higher impact strength than that of the polyethylene by itself. In some cases, a blend of an environmentally friendly hydrogel and polyethylene may desirably exhibit higher tensile strength than that of the polyethylene by itself.

In some embodiments, an environmentally friendly porous hydrogel exhibits properties as described for porous gels and hydrogels below. In some embodiments, an environmentally friendly porous hydrogel can be further combined with an environmentally friendly polymer that is not a polyglycol as described below, such as cellulose. In some embodiments, an environmentally friendly porous hydrogel is formed by the methods described below. In some embodiments, an environmentally friendly porous hydrogel has a composition as described above. In some embodiments, an environmentally friendly porous hydrogel is blended with a material such as fertilizer or soil to provide a blend material with high water-retention capacity.

According to one embodiment, an environmentally friendly porous hydrogel comprising an environmentally friendly polyglycol can be advantageous over hydrogels that comprise toxic polyglycols in that a wider range of uses may be available for hydrogels that do not contain toxic materials. For example, an environmentally friendly porous hydrogel can be used in agricultural or medical applications, or combined with environmentally friendly polymers to provide a blend that is compatible with uses in medicine and agriculture. Further applications of environmentally friendly hydrogels are described.

### Methods for Forming Porous Gels and Hydrogels

In another aspect of the invention, methods for forming porous gels and hydrogels according to some embodiments, are provided.

In another aspect, the present disclosure provides a method of forming a porous hydrogel according to one embodiment, comprising: providing, in a reaction vessel, a monomer having a vinyl functionality, a cross-linker, an organic solvent, a first polymeric material comprising polyacrylic acid, and a second polymeric material comprising a polyglycol other than polyethylene glycol, and mixing the mixture. In one such embodiment, the first polymeric and/or the second polymeric material may be substantially a homopolymer.

In a particular embodiment, the method may further comprise heating the mixture. In some embodiments, the mixture is heated at a temperature between about 50° C. and 90° C. In other embodiments, the mixture is heated for at least 1 hour, at least 2 hours or at least 3 hours, for example.

In one embodiment, the organic solvent may be a solvent immiscible with water. In some cases, the organic solvent is aromatic. In a further embodiment, the organic solvent is toluene. In one embodiment, the organic solvent may play an important role in the formation of the porous hydrogel. The amount of organic solvent used may influence one or more physical property of the hydrogel, such as the porosity of the hydrogel, for example.

In one embodiment, the polymerization reaction forming the hydrogel is an exothermic reaction. Once polymerization starts, an exothermic chain reaction may occur and lead to high temperatures and pressures within reactor, which can lead to possible explosion or violent rupture of the reactor and/or discharge of flammable and/or toxic gases if safety and control systems malfunction. Generally, exothermic reactions may pose special hazards whether occurring in the open or within a closed reactor. Therefore according to one embodiment of the invention, it is desirable to provide and design a reactor to control the internal pressure of the reactor to avoid over-pressurization which may lead to explosion or reactor ruptures and to release heating energy flows out of the system quickly to the external environment. The traditional approach is to cool the reaction while the polymerization proceeds. However, in one aspect of the present invention, a high polymerization temperature may be beneficial. It may increase the ratio of monomers to be polymerized, therefore, leading to a high reaction yield and/or lower impurity of polymer product.

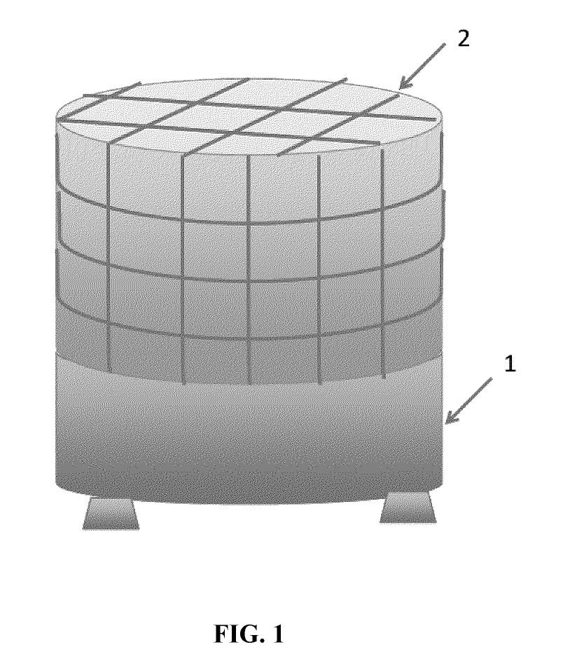

Referring now to FIG. 1, a reactor vessel 1 is provided according to an embodiment of the present invention, as illustrated in the isometric view shown in FIG. 1. In one embodiment, the exemplary reactor vessel as illustrated in FIG. 1 may desirably provide for conducting an exothermic reaction, such as an exothermic polymerization reaction. In one such embodiment, the reactor as depicted in FIG. 1 may be provided for conducting an exothermic polymerization reaction to form a hydrogel according to an embodiment of the invention. In a particular embodiment, the reactor 1 incorporates net-like reactor cap 2. In one such embodiment, the net-like cap 2 may desirably provide structural and/or confining strength to the reactor vessel 1 such as to harden the reactor for use in containing an exothermic reaction, such as a polymerization reaction. In a particular embodiment, the net-like cap 2 may desirably comprise a suitable material providing desirably suitable strength such as tensile strength for strengthening the reactor vessel. In one embodiment, the net-like cap may desirably also comprise a suitable material which is compatible with the material comprising the reactor vessel 1, and/or the components of the reaction conducted therein. In one such embodiment, the net-like cap 2 may desirably comprise a suitably strong steel-less material, such as a steel-less metal, alloy, composite or polymer material, for example.

In another embodiment of the present invention, a method for forming a porous gel or hydrogel may include combining a first polymeric material comprising substantially porous polyacrylic acid, a second polymeric material comprising polytetramethylene ether glycol, and a third polymeric material comprising substantially non-porous polyacrylic acid in a suitable reactor vessel, such as the exemplary reactor vessel 1 as shown in FIG. 1, for example.

### Porous Gel and Hydrogel Properties

In one embodiment, porous gels and hydrogels formed according to methods described herein may desirably have material properties, such as glass transition temperature, viscosity, hardness, conductivity, water absorption ability, air properties, and tensile strength, suited to various uses and applications, such as at least one of: agricultural, medical, bioengineering and chemical applications or purposes.

In an embodiment, a porous gel or hydrogel having a cross-linked PAA and a polyglycol desirably has a rubber-like texture (soft or tough rubber) at a temperature between about 10° C. and 40° C., or 15° C. and 30° C.

In an embodiment, a porous gel or hydrogel formed of a cross-lined PAA and a polyglycol can have a compressive strength of at least about 100 g/cm², or at least about 500 g/cm², or at least about 1,000 g/cm², or at least about 2,000 g/cm², or at least about 3,000 g/cm², or at least about 4,000 g/cm², or at least about 5,000 g/cm², or at least about 6,000 g/cm², or at least about 7,000 g/cm², or at least about 8,000 g/cm², or at least about 9,000 g/cm², or at least about 10,000 g/cm², or at least about 15,000 g/cm², or at least about 20,000 g/cm², or at least about 40,000 g/cm², or at least about 100,000 g/cm², or at least about 200,000 g/cm². In another embodiment, a gel or hydrogel formed of PAA and PTMEG can have a compressive strength of at least about 100 g/cm², or at least about 500 g/cm², or at least about 1,000 g/cm², or at least about 2,000 g/cm², or at least about 3,000 g/cm², or at least about 4,000 g/cm², or at least about 5,000 g/cm², or at least about 6,000 g/cm², or at least about 7,000 g/cm², or at least about 8,000 g/cm², or at least about 9,000 g/cm², or at least about 10,000 g/cm². In another embodiment, a gel or hydrogel formed of PAA and a polyglycol can have a compressive strength of at least about 1,000 g/cm², or 2,000 g/cm², or 3,000 g/cm², or 4,000 g/cm², or 5,000 g/cm², or 6,000 g/cm², or 7,000 g/cm², or 8,000 g/cm² without failure. Compressive strength can be assessed based on stress-strain measurements. In another embodiment, a gel or hydrogel formed of PAA and a polyglycol can have a compressive strength between about 100 g/cm² and 9,000 g/cm². In another embodiment, a gel or hydrogel formed of PAA and PTMEG can have a compressive strength between about 100 g/cm² and 9,000 g/cm².

In an embodiment, a porous gel or hydrogel formed of a cross-linked PAA and a polyglycol can have a tensile strength of at least about 100 g/cm², or at least about 500 g/cm², or at least about 1,000 g/cm², or at least about 2,000 g/cm², or at least about 3,000 g/cm², or at least about 4,000 g/cm², or at least about 5,000 g/cm², or at least about 6,000 g/cm², or at least about 7,000 g/cm², or at least about 8,000 g/cm², or at least about 9,000 g/cm², or at least about 10,000 g/cm², or at least about 15,000 g/cm², or at least about 20,000 g/cm², or at least about 40,000 g/cm², or at least about 100,000 g/cm², or at least about 200,000 g/cm². In another embodiment, a gel or hydrogel formed of PAA and PTMEG can have a tensile strength of at least about 100 g/cm², or at least about 500 g/cm², or at least about 1,000 g/cm², or at least about 2,000 g/cm², or at least about 3,000 g/cm², or at least about 4,000 g/cm², or at least about 5,000 g/cm², or at least about 6,000 g/cm², or at least about 7,000 g/cm², or at least about 8,000 g/cm², or at least about 9,000 g/cm², or at least about 10,000 g/cm². In another embodiment, a gel or hydrogel formed of PAA and a polyglycol can have a tensile strength of at least about 1,000 g/cm², or 2,000 g/cm², or 3,000 g/cm², or 4,000 g/cm², or 5,000 g/cm², or 6,000 g/cm², or 7,000 g/cm², or 8,000 g/cm² without failure. Tensile strength can be assessed based on stress-strain measurements. In another embodiment, a gel or hydrogel formed of PAA and a polyglycol can have a tensile strength between about 100 g/cm² and 9,000 g/cm². In another embodiment, a gel or hydrogel formed of PAA and PTMEG can have a tensile strength between about 100 g/cm² and 9,000 g/cm².

In one embodiment, the hydrogel may remain substantially unchanged after 1, 2, 5, 10, 50, or 100 hydration-dehydration cycles. In one such embodiment, the hydrogel may have a water-retention capacity of at least about 10, at least about 20, at least about 30, or at least about 50 times the weight of the hydrogel. In another embodiment, the hydrogel may have a water-retention capacity of at least about 10%, at least about 20%, at least about 30%, at least about 40%, at least about 50%, at least about 60%, at least about 100%, or at least about 1000% of the weight of the hydrogel.

### Soils and Seeds

In some embodiments, a plot of soil may be provided comprising soil and a porous hydrogel in the soil. In one such embodiment, a porous hydrogel provided can have a composition substantially as described according to one or more embodiments herein. In one example, a porous hydrogel which may be comprised in or mixed with soil may comprise a first polymeric material comprising substantially porous polyacrylic acid, a second polymeric material comprising polytetramethylene ether glycol, and a third polymeric material comprising substantially non-porous polyacrylic acid.

In some embodiments, the second polymeric material is substantially a homopolymer. In some embodiments, the third polymeric material is substantially a homopolymer. In one embodiment, the second polymeric material can be hydrogen bonded to the first and third polymeric material.

In some embodiments, a seed configured to grow in an arid environment is provided. The seed is provided in a system comprising a seed container having a porous gel or hydrogel such as described according to one or more embodiments herein. The seed is disposed in the seed container. For example, in one embodiment the seed container can be formed of a first polymeric material comprising substantially porous polyacrylic acid, a second polymeric material comprising polytetramethylene ether glycol, and a third polymeric material comprising substantially non-porous polyacrylic acid.

In another embodiment, a porous hydrogel can be placed in a plot of soil. The plot can have various shapes and sizes, e.g., circular, a triangular, square or rectangular plots. The plot can have a size of at least 0.1 ft², or 1 ft², or 2 ft², or 3 ft², or 4 ft², or 5 ft², or 25 ft², or 50 ft², or 100 ft², or 5000 ft², or 1,000 ft², or 10,000 ft², or more, as may be suited to a desired application, such as an agricultural application, for example.

### Examples of Hydrogel Compositions and/or Methods of Production

### Example 1

According to one embodiment, 100 g of acrylic acid was dissolved into 300 g of water (Solution A). And, 54 g of potassium hydroxide was dissolved into Solution A under cooling. The mixture was placed into a 2 L round bottle flask equipped mechanical mixer, temperature controller and heating mantel. Then, 0.3 g of N,N′-methylene bisacrylamide and 1.5 g of potassium persulfate were added. Also, 10 g of polyacrylic acid and 20 g of PTMG were added into the 2 L flask under stir. Then, 50 g of toluene and 2 g of Tween® 20 (polysorbate 20) were added into the above mixture. Under vigorous stir, an emulsion was formed. The polymerization reaction was conducted at an initial temperature of 55° C. and then up to 85-90° C. for two hours to provide a hydrogel according to an embodiment of the present invention.

### Example 2

According to another embodiment of the present invention, 3 kg of acrylic acid was dissolved into 4.5 L of water (to provide a Solution A), and 1620 g of potassium hydroxide was dissolved into 4.5 L of cold water (to provide a Solution B). Solution A and Solution B were mixed under stir. The mixture was placed into a 22 L round bottle flask equipped mechanical mixer, temperature controller and heating mantel. Then, 9.0 g of N,N′-methylene bisacrylamide and 45 g of potassium persulfate were added. Also, 30 g of polyacrylic acid and 60 g of PTMG were added into the 22 L flask under stir. And then, 1.5 kg of toluene and 25 g of Tween® 20 (polysorbate 20) were added into the mixture. Under vigorous stir, an emulsion was formed. The polymerization reaction was conducted at an initial temperature of 50-55° C. and then up to 85-90° C. for three hours to provide a hydrogel according to an embodiment of the present invention. The bulk hydrogel product was then cut by using a grinder and then dried at 70° C. The dried hydrogel product was found to have an absorbency of tap water of approximately 200-250 times its dry weight.

### Example 3

According to another embodiment of the present invention, 3 kg of acrylic acid was dissolved into 4.5 L of water (to provide a Solution A), and 1.16 kg of Miracle-Gro® Plant Food 24-8-16 was dissolved into 4.5 L of cold water (to provide a Solution B). Solution A and Solution B were mixed under stir. The mixture was placed into a 22 L round bottle flask equipped mechanical mixer, temperature controller and heating mantel. Then, 9.0 g of N,N′-methylene bisacrylamide and 45 g of potassium persulfate were added. Also, 30 g of polyacrylic acid and 60 g of PTMG were added into the 22 L flask under stir. And then, 1 kg of toluene and 15 g of Tween® 20 (polysorbate 20) were added into the mixture. Under vigorous stir, an emulsion was formed. The polymerization reaction was conducted at an initial temperature of 50-55° C. and then up to 85-90° C. for three hours to provide a hydrogel according to an embodiment of the present invention. The bulk hydrogel product was then cut by using a grinder.

### Example 4

According to another embodiment of the present invention, a non-porous and porous hydrogel were mixed together to get a fast absorbing gel. The ratio of non-porous gel and porous gel was adjusted to obtain a desired absorption rate, and the adsorption rates were measured for the progressive adsorption of 300 mL of water for each of five mixtures of non-porous and porous hydrogels in the mixture ratios as shown in Table 1 below:

TABLE 1
Improvement of absorption rate by
mixing non-porous with porous gel

| | Non-porous to porous hydrogel ratio | | | | |
|---|---|---|---|---|---|
| Water added | 10:0 | 9:1 | 8:2 | 7:3 | 6:4 |
| Initial 50 mL | 7 min | 8 min | 6 min | 3 min | 4 min |
| Further 100 mL | 7 min | 4 min | 2 min | 2 min | 3 min |
| added (150 mL | | | | | |
| total) | | | | | |
| Further 150 mL | 17 min | 18 min | 18 min | 10 min | 6 min |
| added (300 mL | | | | | |
| total) | | | | | |
| Duration for | 31 min | 32 min | 26 min | 15 min | 13 min |
| Total 300 mL | | | | | |

### Example 5

According to another embodiment of the present invention, an oil-in-water emulsion polymerization was followed to produce a hydrogel. An aqueous solution was prepared by adding 2333 gm acrylic acid, 1260 gm potassium hydroxide, 7.0 gm N,N′-bisacrylamide, 23.3 gm poly(acrylic acid), 46.6 gm poly(tetrahydrofuran), 35 gm potassium persulfate, and 52 mL Tween®-20 (polysorbate 20) to 4200 mL of water in a 22-liter glass reactor with a mechanical stirrer, under stir at 250 rpm. The temperature was controlled to remain under 55° C. during mixing. An emulsion was prepared by adding 2598 gm of toluene to the above-described aqueous phase solution, under stir with a mechanical stirrer at 1400 rpm for 5-10 minutes. The polymerization reaction was carried out by raising the temperature of the emulsion to 65-67° C.

The resultant polymer was dehydrated and toluene was extracted by immersing in methanol for 12 hours. The product was collected by vacuum filtration and dried in a 50° C. oven for 8 hours. The dry bulk polymer product was ground using a heavy-duty blender. The resulting polymer product powder was then extracted by immersion in methanol for 12 hours, collected by vacuum filtration and dried in a 50° C. oven for 8 hours. The dried powder was then separated by particle size using 0.6 mm and 2 mm mesh sieve separators, and the fraction with particle size smaller than 0.6 mm was retained. The bulk density of the fraction with particle size smaller than 0.6 mm (<0.6 mm) was measured and found to be 0.87 g/mL.

### Example 6

According to another embodiment of the present invention, a further oil-in-water emulsion polymerization was followed to produce a hydrogel. An aqueous solution was prepared by adding 1600 gm acrylic acid, 864 gm potassium hydroxide, 4.8 gm N,N′-bisacrylamide, 16.0 gm poly(acrylic acid), 32.0 gm poly(tetrahydrofuran), 24.0 gm potassium persulfate, and 50.2 mL Tween®-20 (polysorbate 20) to 3200 mL of water in a 22-liter glass reactor with a mechanical stirrer, under stir at 250 rpm. The temperature was controlled to remain under 55° C. during mixing. An emulsion was prepared by adding 2771.2 gm of toluene to the above-described aqueous phase solution, under stir with a mechanical stirrer at 1400 rpm for 5-10 minutes. The polymerization reaction was carried out by raising the temperature of the emulsion to 65-67° C.

The resultant polymer was dehydrated and toluene was extracted by immersing in methanol for 12 hours. The product was collected by vacuum filtration and dried in a 50° C. oven for 8 hours. The dry bulk polymer product was ground using a heavy-duty blender. The resulting polymer product powder was then extracted by immersion in methanol for 12 hours, collected by vacuum filtration and dried in a 50° C. oven for 8 hours. The dried powder was then separated by particle size using 0.6 mm and 2 mm mesh sieve separation, and the fraction with particle size smaller than 0.6 mm was retained. The bulk density of the fraction with particle size smaller than 0.6 mm (<0.6 mm) was measured and found to be 0.59 g/mL.

### Example 7

According to another embodiment of the present invention, a further oil-in-water emulsion polymerization was followed to produce a hydrogel. An aqueous solution was prepared by adding 1333 gm acrylic acid, 720 gm potassium hydroxide, 4.0 gm N,N′-bisacrylamide, 13.3 gm poly(acrylic acid), 26.6 gm poly(tetrahydrofuran), 20.0 gm potassium persulfate, and 69.3 mL Tween®-20 (polysorbate 20) to 2660 mL of water in a 22-liter glass reactor with a mechanical stirrer, under stir at 250 rpm. The temperature was controlled to remain under 55° C. during mixing. An emulsion was prepared by adding 3464 gm of toluene to the above-described aqueous phase solution, under stir with a mechanical stirrer at 1400 rpm for 5-10 minutes. The polymerization reaction was carried out by raising the temperature of the emulsion to 65-67° C.

The resultant polymer was dehydrated and toluene was extracted by immersing in methanol for 12 hours. The product was collected by vacuum filtration and dried in a 50° C. oven for 8 hours. The dry bulk polymer product was ground using a heavy-duty blender. The resulting polymer product powder was then extracted by immersion in methanol for 12 hours, collected by vacuum filtration and dried in a 50° C. oven for 8 hours. The dried powder was then separated by particle size using 0.6 mm and 2 mm mesh sieve separation, to provide fractions with particle size smaller than 0.6 mm, between 0.6 mm and 2 mm, and larger than 2 mm.

### Example 8

According to another embodiment of the present invention, a further oil-in-water emulsion polymerization was followed to produce a hydrogel. An aqueous solution was prepared by adding 1870 gm acrylic acid, 864 gm potassium hydroxide, 5.6 gm N,N′-bisacrylamide, 18.7 gm poly(acrylic acid), 37.3 gm poly(tetrahydrofuran), and 35.0 gm potassium persulfate, to 3733 mL of water in a 22-liter glass reactor with a mechanical stirrer, under stir at 250 rpm. An oil phase was separately prepared by adding 46 mL of SPAN® 80 (sorbitan monooleate) to 2078 gm of toluene under stir at 250 rpm with a mechanical stirrer. The temperature was controlled to remain under 55° C. during mixing. An emulsion was prepared by adding the above-described oil phase to the above-described aqueous phase solution, under stir with a mechanical stirrer at 1400 rpm for 5-10 minutes. The polymerization reaction was carried out by raising the temperature of the emulsion to 65-67° C.

The resultant polymer was dehydrated and toluene was extracted by immersing in methanol for 12 hours. The product was collected by vacuum filtration and dried in a 50° C. oven for 8 hours. The dry bulk polymer product was ground using a heavy-duty blender. The resulting polymer product powder was then extracted by immersion in methanol for 12 hours, collected by vacuum filtration and dried in a 50° C. oven for 8 hours. The dried powder was then separated by particle size using 0.6 mm and 2 mm mesh sieve separation, and the fraction with particle size smaller than 0.6 mm was retained. The bulk density of the fraction with particle size smaller than 0.6 mm (<0.6 mm) was measured and found to be 0.96 g/mL.

### Example 9

According to another embodiment of the present invention, a further oil-in-water emulsion polymerization was followed to produce a hydrogel. An aqueous solution was prepared by adding 1600 gm acrylic acid, 864 gm potassium hydroxide, 4.8 gm N,N′-bisacrylamide, 16.0 gm poly(acrylic acid), 32.0 gm poly(tetrahydrofuran), and 24.0 gm potassium persulfate, to 3200 mL of water in a 22-liter glass reactor with a mechanical stirrer, under stir at 250 rpm. An oil phase was separately prepared by adding 56 mL of SPAN® 80 (sorbitan monooleate) to 2771 gm of toluene under stir at 250 rpm with a mechanical stirrer. The temperature was controlled to remain under 55° C. during mixing. An emulsion was prepared by adding the above-described oil phase to the above-described aqueous phase solution, under stir with a mechanical stirrer at 1400 rpm for 5-10 minutes. The polymerization reaction was carried out by raising the temperature of the emulsion to 65-67° C.

The resultant polymer was dehydrated and toluene was extracted by immersing in methanol for 12 hours. The product was collected by vacuum filtration and dried in a 50° C. oven for 8 hours. The dry bulk polymer product was ground using a heavy-duty blender. The resulting polymer product powder was then extracted by immersion in methanol for 12 hours, collected by vacuum filtration and dried in a 50° C. oven for 8 hours. The dried powder was then separated by particle size using 0.6 mm and 2 mm mesh sieve separation, and the fraction with particle size smaller than 0.6 mm was retained. The bulk density of the fraction with particle size smaller than 0.6 mm (<0.6 mm) was measured and found to be 0.88 g/mL.

### Example 10

According to another embodiment of the present invention, a further oil-in-water emulsion polymerization was followed to produce a hydrogel. An aqueous solution was prepared by adding 1333 gm acrylic acid, 720 gm potassium hydroxide, 4.0 gm N,N′-bisacrylamide, 13.3 gm poly(acrylic acid), 26.6 gm poly(tetrahydrofuran), and 20.0 gm potassium persulfate, to 2666 mL of water in a 22-liter glass reactor with a mechanical stirrer, under stir at 250 rpm. An oil phase was separately prepared by adding 69 mL of SPAN® 80 (sorbitan monooleate) to 3464 gm of toluene under stir at 250 rpm with a mechanical stirrer. The temperature was controlled to remain under 55° C. during mixing. An emulsion was prepared by adding the above-described oil phase to the above-described aqueous phase solution, under stir with a mechanical stirrer at 1400 rpm for 5-10 minutes. The polymerization reaction was carried out by raising the temperature of the emulsion to 65-67° C.

The resultant polymer was dehydrated and toluene was extracted by immersing in methanol for 12 hours. The product was collected by vacuum filtration and dried in a 50° C. oven for 8 hours. The dry bulk polymer product was ground using a heavy-duty blender. The resulting polymer product powder was then extracted by immersion in methanol for 12 hours, collected by vacuum filtration and dried in a 50° C. oven for 8 hours. The dried powder was then separated by particle size using 0.6 mm and 2 mm mesh sieve separation, to provide fractions with particle size smaller than 0.6 mm, between 0.6 mm and 2 mm, and larger than 2 mm.

### Example 11

According to another embodiment of the present invention, five sample mixtures of mixed porous and non-porous hydrogels were prepared by mixing a typically non-porous Bountigel™ hydrogel powder (such as is available from mOasis Inc. of Union City, Calif., USA) with varying amounts of the exemplary porous hydrogel prepared as described in Example 6 above. As noted in Table 2 below, the porous hydrogel from Example 6 of the present disclosure was added to the exemplary Bountigel™ non-porous hydrogel in ratios varying from none (control or zero parts porous hydrogel), to 4:6. Water was then added to the hydrogel mixtures in portions of 30 mL each and the time required for absorption of each 30 mL portion by each hydrogel mixture was recorded, as shown in Table 2 below.

TABLE 2

| | Ratio of BountiGel non-porous hydrogel(g)/ | | | | |
|---|---|---|---|---|---|
| | Example 6 porous hydrogel (g) | | | | |
| | 1.0/0.0 | 0.9/0.1 | 0.8/0.2 | 0.7/0.3 | 0.6/0.4 |
| Absorbed Water | Time | Time | Time | Time | Time |
| Volume (mL) | (s) | (s) | (s) | (s) | (s) |
| 30 | 71 | 45 | 33 | 28 | 24 |
| 60 | 176 | 141 | 112 | 87 | 77 |
| 90 | 302 | 272 | 213 | 163 | 143 |
| 120 | 513 | 471 | 399 | 337 | 293 |

As can be seen from the elapsed time required for absorption shown in Table 2 above, the increasing addition of porous hydrogel from Example 6 to the non-porous hydrogel resulted in progressively reduced time for absorption of water, and thereby provided for an increased water absorption rate compared with the hydrogel mixtures having less or no porous hydrogel component. Accordingly, in one embodiment of the present invention, a porous hydrogel, such as may be formed using an emulsion polymerization technique as described above in Examples 5-10, may desirably provide for increased rate of water absorption in mixtures with non-porous hydrogels.

While preferable embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A hydrogel, comprising:
a first polymeric material comprising a polymer derived from a monomer with a vinyl functionality, and
a second polymeric material having a polyglycol other than polyethylene glycol,
wherein the hydrogel has a porosity of at least 5%.

2. The hydrogel of claim 1, wherein said first polymeric material comprises a cross-linker.

3. The hydrogel of claim 2 wherein said cross-linker comprises at least one of: di(ethyleneglycol) divinyl ether, di(ethylglycol) diacrylate, and N,N′-methylene bis(acrylamide).

4. The hydrogel of claim 1, wherein said first polymeric material comprises a cross-linked polyacrylic acid.

5. The hydrogel of claim 1, wherein said second polymeric material comprises polytetramethylene ether glycol.

6. The hydrogel of claim 1, wherein said first polymeric material is hydrogen-bonded to said second polymeric material.

7. The hydrogel of claim 1, further comprising a third polymeric material.

8. The hydrogel of claim 7, wherein at least one of said second and said third polymeric material is substantially a homopolymer.

9. The hydrogel of claim 7, wherein said third polymeric material is substantially non-porous.

10. The hydrogel of claim 1, wherein said hydrogel has a porosity of one of: at least about 10%, at least about 20%, at least about 30%, at least about 40%, at least about 50%, at least about 60% and at least about 70%.

11. The hydrogel of claim 1, wherein said monomer comprises at least one of: acrylic acid, methylacrylic acid, vinyl alcohol, vinyl acetate, butyl acrylate, vinyl acrylate, vinylbenzoic acid, vinylbenzyl alcohol, vinylboronic acid dibutyl ester, vinylformamide, vinyl methacrylate, vinylpyridine, 1-vinyl-2-pyrrolidone, vinylsulfonic acid, and vinyltrimethoxysilane.

12. (canceled)

13. The hydrogel of claim 1, wherein said hydrogel has a water-retention capacity of one of: at least about 10%, at least about 20%, at least about 30%, at least about 100%, at least about 1000%, and at least about 5000% of the weight of the hydrogel.

14. The hydrogel of claim 1, wherein the ratio, by weight, of said first polymeric material to said second polymeric material is one of: about 1:1, about 1:2, about 1:3, and about 1:6.

15. The hydrogel of claim 7, wherein the ratio, by weight, of said first polymeric material to said third polymeric material is one of: about 1:1, about 1:1.2, about 1:1.5, about 1:2, about 1:2.5, about 1:3, about 1:4, and about 1:6.

16-18. (canceled)

19. A method of forming a porous hydrogel, comprising:
providing, in a reaction vessel, a mixture, the mixture comprising:
a monomer having a vinyl functionality;
a cross-linker;
an organic solvent;
a first polymeric material comprising polyacrylic acid; and
a second polymeric material comprising a polyglycol other than polyethylene glycol; and
mixing the mixture to form a hydrogel having a porosity of at least 5%.

20. The method of claim 19, wherein at least one of said first polymeric material and said second polymeric material is substantially a homopolymer.

21. The method of claim 19, wherein said first polymeric material and said second polymeric material are provided in a ratio by weight, respectively, of: 1:1, 1:2, 1:3, and 1:6.

22. The method of claim 19, further comprising heating the mixture at a temperature between approximately 50° C. and approximately 90° C. for at least 1 hour.

23. (canceled)

24. The method of claim 19, wherein said polyacrylic acid comprises recycled polyacrylic acid.

25. The method of claim 19, wherein said cross-linker is selected from the group consisting of di(ethyleneglycol) divinyl ether, di(ethylglycol) diacrylate, and N,N′-methylene bis(acrylamide).

26. The method of claim 19, wherein said solvent comprises toluene.

27-36. (canceled)

37. A system, comprising:
a seed container comprising a hydrogel with a porosity of at least 5%; and
a seed in said seed container.

38-39. (canceled)

40. The system of claim 37, wherein the hydrogel comprises three polymeric materials, wherein the first polymeric material of the three polymeric materials comprises substantially porous polyacrylic acid, the second polymeric material of the three polymeric materials comprises polytetramethylene ether glycol, and the third polymeric material of the three polymeric materials comprises substantially non-porous polyacrylic acid.
